(19) United States
(12) Patent Application Publication
(10) Pub. No.: US 2006/0203693 A1
(43) Pub. Date: Sep. 14, 2006

(54) Optical disc apparatus and method of erasing information recorded thereon

(75) Inventor: Shohei Aoyama, Mito (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/364,981

(22) Filed: Feb. 28, 2006

(30) Foreign Application Priority Data
Mar. 14, 2005 (JP) 2005-071379

(51) Int. Cl. G11B 7/12; G11B 7/00

(52) U.S. Cl. 369/116; 369/59.13; 369/47.53

(57) ABSTRACT

In an optical disc apparatus, before the information already existing on an optical disc is erased, the information recorded in a user data area of the optical disc is test-erased with laser light of previously set erasing power first, then after test recording of information in the user date area and evaluation of the test-recorded information in terms of recording quality, erasing power for actually erasing desired information is set in accordance with evaluation results.

### CLAIM OF PRIORITY

The present application claims priority from Japanese application Ser. No. P2005-071379, filed on Mar. 14, 2005, the content of which is hereby incorporated by reference into this application.

### BACKGROUND OF THE INVENTION

1. Technical Field of the Invention

The present invention relates to an optical disc apparatus, and more particularly, to a technique for erasing recorded information therefrom.

2. Description of the Related Art

In conventional types of optical disc apparatuses, for example, when old information recorded on the optical disc of a different model of apparatus is erased and new information is recorded, if the recording power of the apparatus is inappropriate (e.g., too strong), this usually renders the old information inerasable to the required level or less and thus deteriorates recording quality of the new information subsequently recorded. Technological studies for improving this problem have also been traditionally conducted.

Recorded-information erasing techniques intended to ensure desired recording quality and related to the present invention are described in, for example, Japanese Patent Laid-open Nos. 2003-45031 and 2004-273074. The technique described in Laid-open No. 2003-45031 is as shown below. After a recording test by overwriting in a test-recording area, reference degree of modulation due to incomplete erasure is calculated from a detection signal of the reflected light in the area of the information which has been erased with an optical beam of erasing power, and the calculated value is retained. When information-recording is conducted, a peak value and a bottom value are derived from the detection signal of the reflected light in the erased information area, then the degree of modulation is calculated from the peak value and the bottom value, and the erasing power is changed so that the degree of modulation is close to the reference degree of modulation. The technique described in Laid-open No. 2004-273074 is as shown below. During an overwriting operation on a rewritable optical disc, the section of its information-recording area that contains recorded data is continuously irradiated with laser beams of the multiple erasing power levels produced by changing the above-mentioned erasing power in steps of a given level, and thus the old data recorded on the rewritable optical disc is erased for trial. After this, the old data is read from the thus test-erased section by irradiating laser light of a reading level, and then a section associated with the minimum noise level of the reading signal is irradiated so that the erasing power level of the laser light is set as the optimum erasing power.

However, since the technique described in Laid-open No. 2003-45031, for example, involves determining the optimum erasing power in the test-recording area, recording quality of new information after erasure in a user area needs to be separately confirmed in the user area. Also, the technique described in Laid-open No. 2004-273074 makes it absolutely necessary to use the laser light of multiple erasing power levels (say, 15 levels) to erase and read data, and therefore, setting the optimum erasing power to minimize the noise level could be a time-consuming operation. In addition, in this latter technique, since the noise level during the erasure absolutely needs to be used as the basis for the determination of the optimum erasing power set, the thus-determined optimum erasing power does not always equal the optimum erasing power for achieving desired recording quality.

In order to solve these problems, according to the present invention allowing for the status of the above conventional techniques, in optical disc apparatuses, for example, even when the information recorded on an optical disc of a different model of apparatus is erased and new information is recorded, the appropriate erasing power that allows desired recording quality of the optical disc can be set within a minimum time by directly evaluating an internal recording state of a user area.

An object of the present invention is to provide an optical disc apparatus capable of solving the problems involved, ensuring compatibility and data read/write reliability between optical discs, and being operated very easily and conveniently.

### SUMMARY OF THE INVENTION

The present invention provides a technique that solved the problems involved.

That is, an optical disc apparatus according to the invention is constructed so that when recorded information is erased from an optical disc, recorded information in a user area of the optical disc is test-erased with a laser of previously set erasing power, then after new information has been test-recorded in the user area and recording quality of the new information has been evaluated, appropriate power for actually erasing desired information is set according to particular evaluation results, and the actual erasure is conducted with the laser of the previously set erasing power.

According to the present invention, the appropriate erasing power that allows desired recording quality of an optical disc within in an optical disc apparatus can be set within a minimum time, and reading/writing reliability can be obtained, even for an optical disc on which information has already been recorded in a different model of apparatus.

### BRIEF DESCRIPTION OF THE DRAWINGS

FIG. 1 is a block diagram showing an example of an optical disc apparatus as an embodiment of the present invention; and

FIG. 2 is an explanatory diagram of an operating procedure for erasing information in the optical disc apparatus of FIG. 1.

### DETAILED DESCRIPTION OF THE PREFERRED EMBODIMENTS

An embodiment of the present invention will be described hereunder using the accompanying drawings.

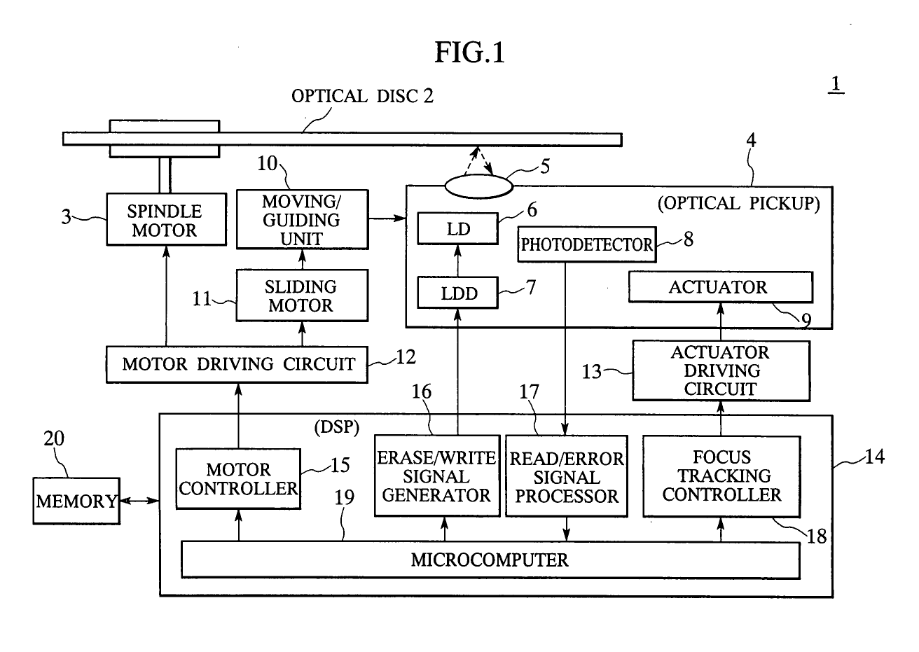

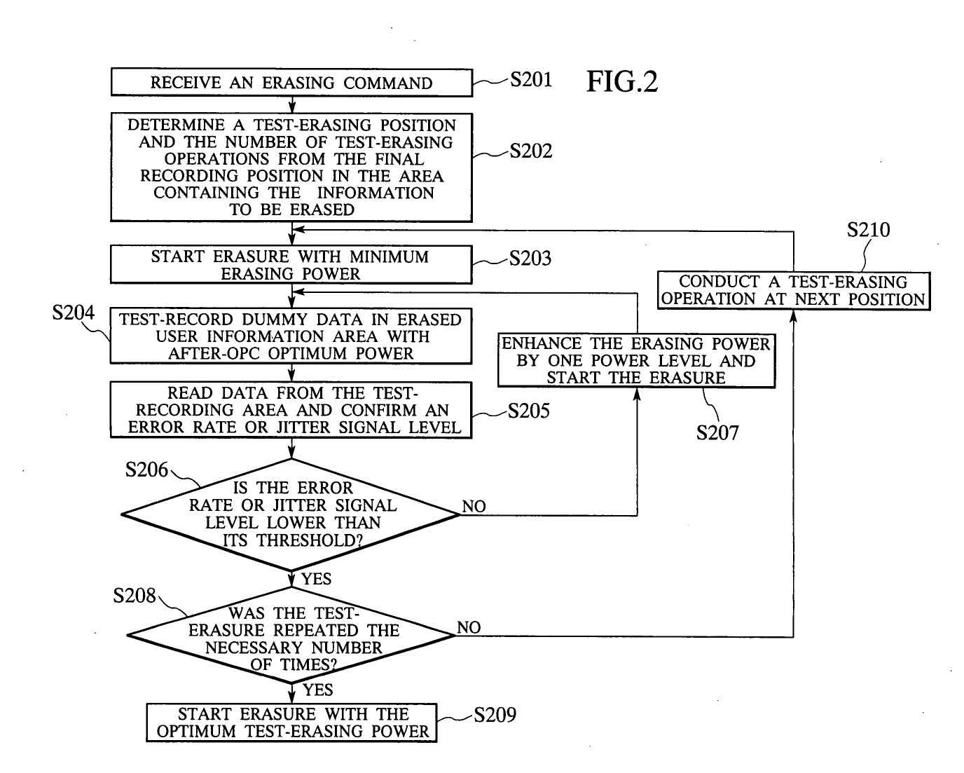

FIGS. 1 and 2 are diagrams that explain the embodiment of the present invention. FIG. 1 is a block diagram showing an example of an optical disc apparatus as the embodiment of the present invention, and FIG. 2 is an explanatory diagram of an operating procedure for erasing information in the optical disc apparatus of FIG. 1.

In FIG. 1, reference number 1 denotes the optical disc apparatus, 2 an optical disc, 3 a spindle motor for rotationally driving the optical disc 2, 4 an optical pickup that irradiates the optical disc 2 with laser light to record information on the optical disc 2 or to read out recorded information therefrom. Reference number 5 denotes an objective lens provided inside the optical pickup 4, 6 a laser diode that generates the laser light, 7 a laser driving circuit that drives the laser diode 6, and 8 a photo detector that receives the laser light from the objective lens 5 and converts the light into electrical signal form. Reference number 9 denotes an actuator that changes a position and attitude of the objective lens 5, 10 a moving/guiding unit that moves the optical pickup 4 while guiding it in approximately a radial direction of the optical disc 2, and 11 a sliding motor for rotating a lead screw (not shown) that is a driving source for the moving/guiding unit 10. Reference number 12 denotes a motor driving circuit for driving the spindle motor 3 and the sliding motor 11, 13 an actuator driving circuit that drives the actuator 9, and 14 a digital signal processor (DSP) that controls the entire optical disc apparatus 1. Reference number 15 denotes a motor controller provided in the DSP 14 in order to form a signal for controlling the motor driving circuit 12, and 16 an erase/write signal generator provided in the DSP 14 in order to generate an erase signal for erasing the information recorded on the optical disc 2, and a write signal for recording new information thereon. Reference number 17 denotes a read/error signal processor disposed in the DSP 4. Depending on an output signal from the photo detector 8, the processor 17 forms a read signal by demodulation or the like or detects writing errors or reading errors and forms an associated error rate signal or a jitter-associated signal or the like. Reference number 18 denotes a focus/tracking controller located in the DSP 14 in order to form a focus control signal or tracking control signal for controlling the actuator driving circuit 13. Reference number 19 denotes a microcomputer functioning as a controller to provide general control of sections such as the motor controller 15, the erase/write signal generator 16, the read/error signal processor 17, and the focus/tracking controller 18. Reference number 20 denotes a memory for data storage.

In the optical disc apparatus 1 of the above configuration, for a recording operation, for instance, when the optical disc 2 is mounted at a required position in the optical disc apparatus 1, an output signal from the motor controller 15 controlled by the microcomputer 19 controls the motor driving circuit 12, rotates the spindle motor 3, and thus rotates the optical disc 2 at a required speed. After the optical disc 2 has started rotating, information that already exists in a user data area on the disc is erased prior to the recording operation (hereinafter, the information is referred to as the recorded old information). The DSP 14, as a controller, conducts the erasure by controlling the laser driving circuit 7 and making the laser diode 6 generate laser light of required erasing power and emit the laser light to the to-be-erased user data area on the optical disc 2 through the objective lens 5. That is, the erase/write signal generator 16 is controlled by an instruction signal from the microcomputer 19 within the DSP 14, then a DC erase signal of a required level, for example, is generated, and this signal is output to the laser driving circuit 7. The laser driving circuit 7 is controlled in accordance with the erase signal, drives the laser diode 6, and generates the laser light of the required erasing power level. Prior to output of the laser light of the required erasing power level from the laser diode 6, the microcomputer 19 sets an appropriate erasing power level that ensures desired recording quality on the optical disc 2. When the microcomputer 19 sets the appropriate erasing power level, the microcomputer 19 first test-erases the recorded old information in the to-be-erased user data area of the optical disc 2 by using the laser light of the required erasing power level which has been set and stored beforehand. Next after causing information to be test-recorded in the user data area, the microcomputer 19 evaluates recording quality of the test-recorded information from the information, such as an error rate signal level or a jitter level, sent from the read/error signal processor 17, and then in accordance with evaluation results, sets erasing power to be used to actually erase desired information. The microcomputer 19 outputs setting results as an instruction signal, and controls the read/error signal generator 16 so that this generator generates an associated erase signal. The laser driving circuit 7 uses the erase signal to drive the laser diode 6 and thus to make this diode generate laser light of the above-set erasing power. The test-recording operation mentioned above is conducted by sending a test-recording signal, such as expression “1” or “0”, from the read/error signal generator 16 to the laser driving circuit 7 to control it and making the laser diode 6 emit appropriate laser light according to a particular test-recording signal level.

When it evaluates recording quality of the test-recorded information, the microcomputer 19 compares the above-received information, such as an error rate signal level or a jitter level, with the previously set reference level. As a result of the comparison, if the received information such as the error rate signal level or jitter level is within the reference level, the test-erasing power used immediately before test recording was conducted is set as erasing power for actual erasure of desired information. This is because actual erasure of information from the intended user data area with the test-erasing power means that desired recording quality of the information subsequently recorded is ensured. Conversely, after the above comparison has been conducted to find that the received information such as the error rate signal level or jitter level is above the reference level, the microcomputer 19 judges that even if the information in the intended user data area is actually erased with the test-erasing power, desired recording quality of the information subsequently recorded is unobtainable. Consequently, the test erasure will be conducted with laser light of an increased erasing power level. After the test erasure at the increased erasing power level, the microcomputer 19 repeats the same sequence as that described above. That is, the microcomputer 19 causes information to be test-recorded in the intended user data area of the optical disc, evaluates recording quality of the test-recorded information from an error rate signal or jitter detection signal (or the like) reproduced from the recorded information, and sets actual (non-test) erasing power according to the evaluation results obtained. That is, immediately after the evaluation, the test-erasing power used if the above error rate signal or jitter level or the like is within the reference level is set as the actual erasing power. The above assumes that the increased erasing power level has also been set and stored in the apparatus beforehand.

A test-erasing position in the intended user data area, the number of test-erasing cycles, and other factors are determined from a final recording position of the recorded old information on the optical disc 2 by the microcomputer 19 when an erasing command from a host computer (not shown) is received by the optical disc apparatus 1.

FIG. 2 is an explanatory diagram of the operating procedure for erasing information in the optical disc apparatus of FIG. 1. In the explanation per FIG. 2, the constituent elements in the above configuration of FIG. 1 are also used with the same reference numbers as those assigned therein.

In FIG. 2, operation progresses in the following sequence:

(1) The optical disc apparatus 1 receives an erasing command from a host computer not shown (step S201).

(2) The microcomputer 19 determines a test-erasing position in the user data area to be erased for trial, the number of test-erasing cycles, and others, from the final recording position of the recorded old information on the optical disc 2 (step S202).

(3) The microcomputer 19 causes the laser diode 6 to emit laser light of relatively low erasing power, and starts the test erasure of the recorded old information in the to-be-erased user data area (step S203).

(4) The microcomputer 19 causes test recording of dummy data in the test-erased user data area at the optimum recording power level obtained after OPC (optical power calibration). (Step S204)

(5) The microcomputer 19 causes the test-recorded data to be read from the to-be-erased user data area, and confirms an error rate signal or a jitter detection level (step S205).

(6) The microcomputer 19 compares the above error rate signal or jitter detection level with the threshold previously set as the required reference level, and judges whether the error rate signal or the jitter detection level is within the threshold, and thus evaluates recording quality of the test-recorded data in the to-be-erased user data area (step S206).

(7) If, as a result of the judgment (comparison) in step S206, the error rate signal or the jitter detection level is above the threshold, the microcomputer 19 increases the erasing power by one level and causes test erasure once again (step S207).

(8) If, as a result of the judgment (comparison) in step S206, the error rate signal or the jitter detection level is within the threshold, the microcomputer 19 judges whether the necessary number of test-erasing operations determined in step S202 have been conducted (step S208).

(9) If, as a result of the judgment in step S208, the necessary number of test-erasing operations have been conducted, the microcomputer 19 sets up, as erasing power for actual erasure of desired information, the optimum erasing power level of all power levels that were used during the test-erasing operations, that is, the erasing power ensuring that the error rate signal or jitter detection level judged in step S208 is within the threshold. (Step S209)

(10) If, as a result of the judgment in step S208, the necessary number of test-erasing operations have not been conducted, the microcomputer 19 causes the recorded old information to be test-erased at a next position in the user data area. (Step S210)

The microcomputer 19 automatically conducts the above series of operations in steps (1) to (10) by executing each thereof in accordance with a program. The present embodiment assumes that the program for causing the microcomputer 19 to execute this procedure is prestored within, for example, the memory 20 of the optical disc apparatus 1.

According to the embodiment of the present invention, based on direct evaluation of an internal recording state of the user data area, the appropriate erasing power that allows desired recording quality of the optical disc to be ensured in the optical disc apparatus can be set within a short time. Consequently, desired reading/writing reliability can also be achieved in, for example, an optical disc on which information has already been recorded using a different model of apparatus, and in higher-speed recording.

While the above embodiment includes the memory 20 disposed independently of the DSP 14, the memory may be contained in the DSP 14 or the microcomputer 19. Also, the microcomputer 19, although provided in the DSP 19, may be provided outside the DSP.

The present invention can be embodied in other specific forms without departing from the spirit or essential characteristics thereof. The invention is therefore not to be considered in all respects as illustrative and not restrictive, the scope of the invention being indicated by the appended claims rather than by the foregoing description, and all changes that come within the meaning and range of equivalency of the claims are therefore intended to be embraced therein.

What is claimed is:

1. An optical disc apparatus that records or reproduces information by irradiating an optical disc with a laser, the apparatus comprising:
a controller which, after causing test erasure of recorded information in a user data area of the optical disc with laser light of previously set erasing power, causes information to be test-recorded in the user data area, then evaluates recording quality of the test-recorded information, and sets erasing power for actually erasing desired information, based on evaluation results.

2. An optical disc apparatus that records or reproduces information by irradiating an optical disc with a laser, the apparatus comprising:
a laser driving circuit that drives a laser diode to generate the laser light irradiated onto the optical disc;
an erase/write signal generator that generates an erase signal or a write signal to control the laser driving circuit in order to make the laser diode generate laser light of information-erasing power or laser light of information-recording power; and
a controller which, for information erasure, after controlling the erase/write signal generator on the basis of command information to make the laser diode generate laser light of previously set erasing power and causing recorded information to be test-erased from a user data area of the optical disc, causes information to be test-recorded in the user data area from which the recorded information has been test-erased, with laser light of required recording power, then evaluates recording quality of the test-recorded information, and sets erasing power for actually erasing desired information, based on results of the evaluation;
wherein desired existing information is actually erased with laser light of the set erasing power.

3. The optical disc apparatus according to claim 1, wherein the controller is adapted to evaluate recording quality of the test-recorded information in accordance with an error signal read therefrom.

4. The optical disc apparatus according to claim 2, wherein the controller is adapted to evaluate recording quality of the test-recorded information in accordance with the error signal read therefrom.

5. The optical disc apparatus according to claim 1, wherein the controller is adapted to set, on the basis of the evaluation results, erasing power of a level equal to or higher than that of the test-erasing power, as the erasing power for actually erasing the desired information.

6. The optical disc apparatus according to claim 2, wherein the controller is adapted to set, on the basis of the evaluation results, erasing power of a level equal to or higher than that of the test-erasing power, as the erasing power for actually erasing the desired information.

7. The optical disc apparatus according to claim 1, wherein the controller is constructed such that after the evaluation, if the recording quality is not up to a reference level, the controller causes test erasure by increasing a level of the erasing power.

8. The optical disc apparatus according to claim 2, wherein the controller is constructed such that after the evaluation, if the recording quality is not up to a reference level, the controller causes test erasure by increasing a level of the erasing power.

9. The optical disc apparatus according to claim 1, wherein the controller is adapted to set, prior to the test erasure, a test-erasing position and the number of test-erasing cycles, from a position at which information has already been recorded on the optical disc.

10. The optical disc apparatus according to claim 2, wherein the controller is adapted to set, prior to the test erasure, a test-erasing position and the number of test-erasing cycles, from a position at which information has already been recorded on the optical disc.

11. A method of erasing the information recorded on an optical disc, wherein, in order to implement the erasure of the recorded information, the method comprises the steps of:
a first step of test-erasing information from a user data area on the optical disc in an erasing mode by making a laser diode generate laser light of previously set erasing power in accordance with command information;
a second step of test-recording information in the user data area from which the information has been test-erased, with laser light of required recording power;
a third step of reading the test-recorded information and evaluating the information in terms of recording quality;
a fourth step of setting an erasing power level for actually erasing desired information, based on results of the evaluation; and
a fifth step of controlling the laser diode so that the diode outputs laser light of the set erasing power level.

12. The method of erasing recorded information according to claim 11, wherein, in the fourth step, erasing power of a level equal to or higher than that of the test-erasing power in the first step is set as the erasing power for actually erasing the desired information.
